(19) United States
(12) Patent Application Publication
(10) Pub. No.: US 2026/0004051 A1
(43) Pub. Date: Jan. 1, 2026

(54) PAGE RENDERING METHOD, DEVICE, AND STORAGE MEDIUM

(71) Applicant: BOE Technology Group Co., Ltd., Beijing (CN)

(72) Inventors: Kun LI, Beijing (CN); Cunqing LI, Beijing (CN); Sujia JIANG, Beijing (CN); Zhenyan ZHAO, Beijing (CN); Zhe ZHANG, Beijing (CN); Naichuan CHEN, Beijing (CN); Hongxiang SHEN, Beijing (CN); Danfeng ZHU, Beijing (CN)

(21) Appl. No.: 18/881,261

(22) PCT Filed: Apr. 28, 2023
(86) PCT No.: PCT/CN2023/091646

§ 371 Date: Jan. 3, 2025

(51) Int. Cl. G06F 40/14; G06F 16/901; G06F 16/958; G06F 40/205

(52) U.S. Cl. CPC G06F 40/14; G06F 16/9027; G06F 16/986; G06F 40/205

(57) ABSTRACT

Page rendering methods, a device, and a storage medium are provided. The method includes: obtaining a DSL file describing a target page including one or more controls; creating a control tree structure including one or more control instances by parsing the obtained DSL file based on a preset DSL parsing module; and rendering the target page according to the created control tree structure.

### TECHNICAL FIELD

The present disclosure relates to a field of computer application technologies, and in particular to page rendering methods and apparatuses, a device, and a storage medium.

### BACKGROUND

With popularity of computers, users usually use more services of the computers, such as querying information, watching videos, browsing web pages, etc.

The users usually need to carry out interactive operations through front-end pages displayed by the computers. For example, a user may download and run an application locally by a terminal, and interact with a front-end page; or the user may open a webpage in a browser for interaction.

However, flexibility of current page rendering is low, resulting in poor user experience.

### SUMMARY

The present disclosure provides page rendering methods and apparatuses, a device, and a storage medium, to solve defects in a related technology.

According to a first aspect of embodiments of the present disclosure, a page rendering method is provided. The method includes: obtaining a domain-specific-language (DSL) file describing a target page including one or more controls; creating a control tree structure including one or more control instances by parsing the obtained DSL file based on a preset DSL parsing module; and rendering the target page according to the created control tree structure. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

Optionally, the method further includes: updating the target page; where the updating the target page specifically includes: obtaining control update data, determining a to-be-updated target control instance and updating the DSL data in the target control instance according to the control update data, executing the rendering function in the updated target control instance to update and render a control corresponding to the target control instance in the target page.

Optionally, the method further includes: creating a corresponding state instance for the each control instance; where different control instances correspond to different state instances, and each of the state instances is enabled to execute the rendering function in a corresponding control instance; where the executing a rendering function in the updated target control instance includes: invoking a state instance corresponding to the target control instance to execute the rendering function in the updated target control instance.

Optionally, each of the state instances is further configured for updating a value of the DSL attribute in the corresponding control instance; the updating DSL data in the target control instance includes: invoking the state instance corresponding to the target control instance to update the DSL data in the target control instance according to the control update data.

Optionally, obtaining the control update data includes: obtaining the control update data according to a local event execution result; and/or obtaining the control update data sent by an external device.

Optionally, a root node of the control tree structure includes a notification center control instance; where the notification center control instance is configured for: in response to receiving a control interaction event, sending information of an interacted control instance to an event parsing processing module, and triggering the event parsing processing module to execute a corresponding operation event and obtain an event execution result; the event parsing processing module includes a set of correspondences between information of the control instances and operation events.

Optionally, the control update data is generated by: obtaining attribute update information of a to-be-updated control; and converting, based on a preset DSL conversion module, the attribute update information into the control update data in a DSL form.

Optionally, the DSL file is generated by: obtaining configuration information of the target page, where the configuration information includes information of the control tree structure; and converting, based on a preset DSL conversion module, the configuration information into the DSL file.

Optionally, the DSL file includes at least one of control information, event binding information, or data binding information describing the control tree structure; the method further includes: executing initialization to generate a data parsing processing module, an event parsing processing module, and a page generation module; saving the event binding information in the DSL file into the event parsing processing module; saving the data binding information in the DSL file into the data parsing processing module; and saving the control information in the DSL file into the page generation module; the creating a control tree structure including one or more control instances by parsing the obtained DSL file includes: invoking the page generation module, to parse the control information and create the control tree structure including the control instances.

Optionally, rendering the target page according to the created control tree structure includes: executing an initialization event for the target page; determining a to-be-updated initial control instance and updating the DSL data in the determined initial control instance according to a result of executing the initialization event; and executing the rendering function in each of the control instances in the control tree structure to render corresponding controls and obtain the target page.

Optionally, the rendering function includes a construction function; the rendering the target page according to the created control tree structure includes: in a process of creating the control tree structure, executing the construction function in each of the control instances included in the control tree structure, to render corresponding controls and obtain the target page.

Optionally, the method further includes: executing an initialization event for the target page; determining a to-be-updated initial control instance and updating the DSL data in the determined initial control instance according to a result of executing the initialization event; and executing the rendering function in the updated initial control instance to update and render a corresponding control in the target page.

Optionally, for each control type, the DSL parsing module includes: a DSL control parsing sub-module corresponding to the each control type; the DSL control parsing sub-module is configured for creating a corresponding control instance by parsing DSL data describing a control instance of the control type; the parsing the obtained DSL file based on a preset DSL parsing module includes: for DSL data describing a control instance of a target control type in the obtained DSL file, invoking a DSL control parsing sub-module corresponding to the target control type in the preset DSL parsing module to parse the DSL data.

Optionally, for each control type, the DSL conversion module includes: a DSL control conversion sub-module corresponding to the each control type; the DSL control conversion sub-module is configured for converting codes for a control instance of the control type into DSL data describing the control instance of the control type.

According to a second aspect of embodiments of the present disclosure, another page rendering method is provided. The page rendering method is applied to a development end and includes: obtaining configuration information of a target page, where the configuration information includes information of a control tree structure; and converting the configuration information into a domain-specific-language (DSL) file describing the target page based on a preset DSL conversion module; where a result of parsing the DSL file is configured for creating the control tree structure including one or more control instances; and the created control tree structure is configured for rendering the target page. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

According to a third aspect of embodiments of the present disclosure, another page rendering method is provided. The page rendering method includes: obtaining, by a development end, configuration information of a target page, where the configuration information includes information of a control tree structure; converting, by the development end, the configuration information into a domain-specific-language (DSL) file describing the target page based on a preset DSL conversion module; and obtaining, by a rendering end, the DSL file, creating the control tree structure including one or more control instances by parsing the obtained DSL file based on a preset DSL parsing module, and rendering the target page according to the created control tree structure. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

According to a fourth aspect of embodiments of the present disclosure, a page rendering apparatus is provided. The apparatus includes: an obtaining unit, configured for obtaining a domain-specific-language (DSL) file describing a target page including one or more controls; and a parsing unit, configured for creating a control tree structure including one or more control instances by parsing the obtained DSL file based on a preset DSL parsing module, and rendering the target page according to the created control tree structure. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

Optionally, the apparatus further includes an update unit configured for updating the target page; and the updating the target page specifically includes: obtaining control update data, determining a to-be-updated target control instance and updating the DSL data in the target control instance according to the obtained control update data, executing the rendering function in the updated target control instance to update and render a control corresponding to the target control instance in the target page.

Optionally, the parsing unit is further configured for: creating a corresponding state instance for the each control instance; where different control instances correspond to different state instances, and each of the state instances is enabled to execute the rendering function in a corresponding control instance; the update unit is configured for: invoking a state instance corresponding to the target control instance to execute the rendering function in the updated target control instance.

Optionally, each of the state instances is further configured for updating a value of the DSL attribute in the corresponding control instance; the update unit is configured for: invoking the state instance corresponding to the target control instance to update the DSL data in the target control instance according to the control update data.

Optionally, the update unit is further configured for: obtaining the control update data according to a local event execution result; and/or obtaining the control update data sent by an external device.

Optionally, a root node of the control tree structure includes a notification center control instance; where the notification center control instance is configured for: in response to receiving a control interaction event, sending information of an interacted control instance to an event parsing processing module, and triggering the event parsing processing module to execute a corresponding operation event and obtain an event execution result; the event parsing processing module includes a set of correspondences between information of the control instances and operation events.

Optionally, the control update data is generated by: obtaining attribute update information of a to-be-updated control; and converting, based on a preset DSL conversion module, the attribute update information into the control update data in a DSL form.

Optionally, the DSL file is generated by: obtaining configuration information of the target page, where the configuration information includes information of the control tree structure; and converting, based on a preset DSL conversion module, the configuration information into the DSL file.

Optionally, the DSL file includes at least one of control information, event binding information, or data binding information describing the control tree structure; the parsing unit is further configured for: executing initialization to generate a data parsing processing module, an event parsing processing module, and a page generation module; saving the event binding information in the DSL file into the event parsing processing module; saving the data binding information in the DSL file into the data parsing processing module; saving the control information in the DSL file into the page generation module; and invoking the page generation module, to parse the control information and create the control tree structure including the control instances.

Optionally, the parsing unit is configured for: executing an initialization event for the target page; determining a to-be-updated initial control instance and updating DSL data in the determined initial control instance according to a result of executing the initialization event; and executing the rendering function in each of the control instances in the control tree structure to render corresponding controls and obtain the target page.

Optionally, the rendering function includes a construction function; and the parsing unit is configured for: in a process of creating the control tree structure, executing the construction function in each of the control instances included in the control tree structure, to render corresponding controls and obtain the target page.

Optionally, the parsing unit is further configured for: executing an initialization event for the target page; determining a to-be-updated initial control instance and updating DSL data in the determined initial control instance according to a result of executing the initialization event; and executing the rendering function in the updated initial control instance to update and render a corresponding control in the target page.

Optionally, for each control type, the DSL parsing module includes: a DSL control parsing sub-module corresponding to the each control type; the DSL control parsing sub-module is configured for: creating a corresponding control instance by parsing DSL data describing a control instance of the control type; the parsing unit is configured for: for DSL data describing a control instance of a target control type in the obtained DSL file, invoking a DSL control parsing sub-module corresponding to the target control type in the preset DSL parsing module to parse the DSL data.

Optionally, for each control type, the DSL conversion module includes: a DSL control conversion sub-module corresponding to the each control type; the DSL control conversion sub-module is configured for converting codes for a control instance of the control type into DSL data describing the control instance of the control type.

According to a fifth aspect of embodiments of the present disclosure, another page rendering apparatus is provided. The page rendering apparatus is applied to a development end and includes: a configuration unit, configured for obtaining configuration information of a target page, where the configuration information includes information of a control tree structure; and a conversion unit, configured for converting the configuration information into a domain-specific-language (DSL) file describing the target page based on a preset DSL conversion module; where a result of parsing the DSL file is configured for creating the control tree structure including one or more control instances; and the created control tree structure is configured for rendering the target page. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

According to a sixth aspect of embodiments of the present disclosure, a page rendering system is provided. The page rendering system includes a development end and a rendering end; where the development end is configured for: obtaining configuration information of a target page, where the configuration information includes information of a control tree structure; and converting the configuration information into a domain-specific-language (DSL) file describing the target page based on a preset DSL conversion module; and where the rendering end is configured for: obtaining the DSL file, creating the control tree structure including one or more control instances by parsing the obtained DSL file based on a preset DSL parsing module, and rendering the target page according to the created control tree structure. Where each of the control instances in the control tree structure includes: a rendering function and a DSL attribute; for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

According to the above embodiments, it can be seen that the DSL file describing the target page is obtained and parsed, and the target page may be rendered in real time, which improve the flexibility of the page rendering.

It should be understood that the above general description and the detailed description in the following text are only exemplary and explanatory, and cannot limit the present disclosure.

### BRIEF DESCRIPTION OF DRAWINGS

The accompanying drawings here are incorporated into the description and form a part of this description, show embodiments conforming to the present disclosure and are used together with the description to explain principles of the present disclosure.

FIG. 1 is a schematic flowchart of a page rendering method shown according to an embodiment of the present disclosure.

FIG. 2 is another schematic flowchart of a page rendering method shown according to an embodiment of the present disclosure.

FIG. 3 is another schematic flowchart of a page rendering method shown according to an embodiment of the present disclosure.

FIG. 4 is a schematic principle diagram of a page updating method shown according to an embodiment of the present disclosure.

FIG. 5 is a schematic flowchart of a page rendering and updating method shown according to an embodiment of the present disclosure.

FIG. 6 is a schematic structural diagram of a page rendering apparatus shown according to an embodiment of the present disclosure.

FIG. 7 is another schematic structural diagram of a page rendering apparatus shown according to an embodiment of the present disclosure.

FIG. 8 is a schematic structural diagram of a page rendering system shown according to an embodiment of the present disclosure.

FIG. 9 is a schematic diagram of a hardware structure of a computer device for configuring a method of an embodiment of the present disclosure, shown according to an embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with the present disclosure. Rather, they are merely examples of apparatuses and methods consistent with some aspects of the present disclosure as detailed in the appended claims.

It should be noted that user information (including but not limited to user device information, user personal information, etc.) and data (including but not limited to data for parsing, data for storage, data for display, etc.) involved in the present disclosure are information and data that are authorized by the user or fully authorized by various parties, and collection, use, and processing of related data need to comply with related laws and regulations and standards of related countries and regions, and are provided with corresponding operation portals for the user to select authorization or rejection.

With popularity of computers, users usually use more services of the computers, such as querying information, watching videos, browsing web pages, etc.

The users usually need to carry out interactive operations through front-end pages displayed by the computers. For example, a user may download and run an application locally by a terminal, and interact with a front-end page; or the user may open a webpage in a browser for interaction.

However, flexibility of current page rendering is low, resulting in poor user experience.

For example, a current front-end page usually does not have a capability of hot update, resulting in that a user may delay obtaining a latest version of the front-end page, and the user experience is poor.

For example, for an application run locally by a terminal, because the application does not have a capability of hot-updating a front-end page, the application usually needs to be deleted and a latest version of the application needs to be re-downloaded, and the user experience is poor.

To solve the above problems, an embodiment of the present disclosure provides a page rendering method.

In this method, an intermediate language file describing a page with an intermediate language may be obtained, then the intermediate language file may be parsed in real time, a corresponding control instance is created according to a result of parsing the intermediate language file, and the page is rendered in real time. The intermediate language may specifically be a language that can be parsed into executable codes, for example, a self-defined language, which is convenient to be parsed into the executable codes. The executable codes may specifically have better interpretability, may be convenient for professional personnel to view, and may specifically be pseudo codes.

The page is composed of controls. The page may be obtained by creating control instances and rendering corresponding controls.

Compared with the case that an executable file for the page is directly downloaded when an application is downloaded, resulting in that the page cannot be updated in a running process in conventional technologies, in this method, the page may be rendered in real time by parsing the intermediate language file describing the page in real time, which improves the flexibility of the page rendering, and then conveniently achieves the hot update of the page.

Specifically, the intermediate language file obtained in the method may be obtained locally from the terminal, or the latest version of page may be obtained from a server-side corresponding to the application for rendering.

For example, a file describing a latest version of page with the intermediate language may be obtained from the server-side corresponding to the application, then the file may be parsed in real time, a corresponding control instance may be created according to a result of parsing the intermediate language file, and the latest version of page is rendered in real time, to implement the hot update of the page.

Therefore, according to the method, the intermediate language file describing the page may be parsed in real time, the page may be rendered in real time, which improves the flexibility of the page rendering, and then conveniently achieves the hot update of the page.

In a specific page hot update instance, the hot update may be executed for a page on a terminal application or a browser. For example, the version of the application may be updated by a development end, to update layout in the page or update the control included in the page; or layout in a browser page or a control included in the browser page may be updated by the terminal locally.

The page rendering method provided in an embodiment of the present disclosure will be described in detail bellow.

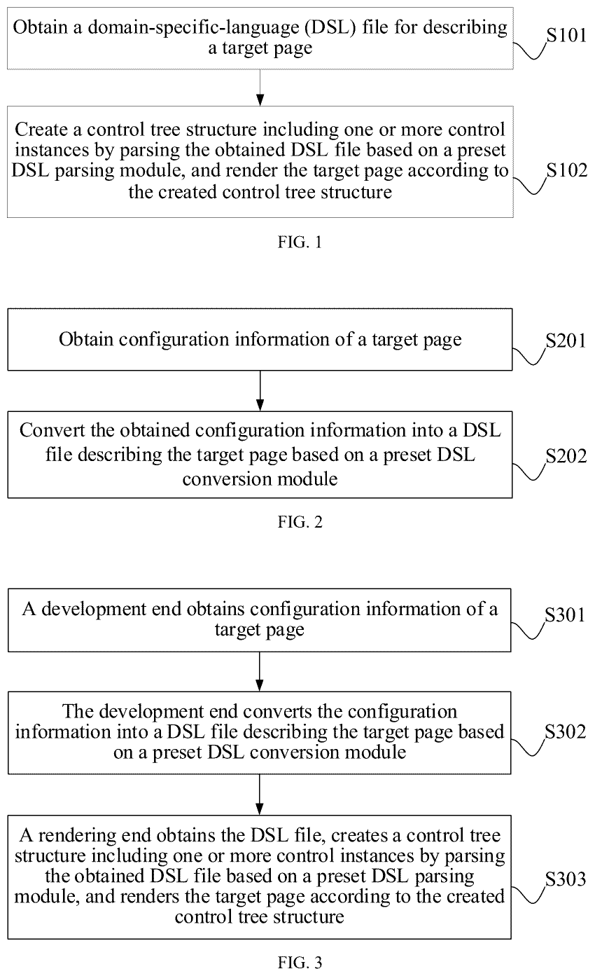

As shown in FIG. 1, FIG. 1 is a schematic flowchart of a page rendering method shown according to an embodiment of the present disclosure.

A body of executing (or an execution body) the method flow is not limited in the embodiment of the present disclosure. Optionally, the body of executing may include any one of: a terminal, an application, a browser, a server-side, etc.

This method may include the following steps S101˜S102.

At step S101, a domain-specific-language (DSL) file describing a target page is obtained.

Optionally, the target page may include one or more controls.

At step S102: a control tree structure including one or more control instances is created by parsing the obtained DSL file based on a preset DSL parsing module, and the target page is rendered according to the created control tree structure.

Optionally, each of the control instances in the control tree structure may include: a rendering function and a DSL attribute.

Optionally, a value of the DSL attribute may include DSL data describing a control instance to which the DSL attribute belongs.

Optionally, the rendering function may be configured for rendering a corresponding control according to the current attribute value of a control instance to which the rendering function belongs, where the current attribute value of the control instance is determined from the DSL data within a current value of the DSL attribute of the control instance to which the rendering function belongs.

According to the above method flow, the DSL file describing the target page may be obtained and parsed, and the target page may be rendered in real time, which improve the flexibility of the page rendering.

Because the above method flow refers to rendering the described target page according to the DSL file obtained in real time, content of the rendered target page is relatively flexible and may change flexibly according to content of the DSL file.

Optionally, the target page may be a latest version of page, such that the page may be hot-updated in a running process by the above method flow. Specifically, the DSL file describing a new page may be obtained in real time for parsing and page rendering, such that the page may be hot-updated in the running process.

In an optional embodiment, the target page may be rendered based on a Flutter framework, and the target page may be configured based on the Flutter framework. The Flutter framework has a cross-platform characteristic, such that versions of multiple platforms may be obtained based on a single development, reducing development cost of the multiple platforms.

Optionally, the controls in the method flow may include one or more widgets, and may specifically include widgets with a type, such as a button, a text, a panel, a list, a picture, etc.

The above method flow is described in detail below.

### I. At Step S101, a Domain-Specific-Language (DSL) File Describing a Target Page is Obtained.

Optionally, the target page may include one or more controls.

### 1) in the Method Flow, a Specific Form of the Domain-Specific-Language (DSL) is not Limited, and a Specific Format of the DSL File is Also not Limited.

For example, for a document writing task, a lightweight markup language (Markdown) may be used as a DSL language; for a string matching task, a regular expression (RegExp) may be used as a DSL language; for a work process control task, a dependency detection tool (Make) language or an automatic construction tool (Gradle) language may be used as a DSL language; for a data query task, a structured query language (SQL) may be used as a DSL language; and for a webpage style coding task, a cascading style sheet (CSS) language may be used as a DSL language, etc. A code file obtained through DSL writing is the DSL file, and correspondingly, specific formats of DSL files corresponding to different DSL languages are also different. Specific programming languages used by the DSL files and formats of the DSL files are not limited in the present disclosure.

Optionally, the domain-specific-language may include any one of: pseudo code, a user self-defined programming language, Chinese, etc. Optionally, the format of the DSL file may be a json format or another format.

Optionally, the DSL file may be used as an intermediate language file, to facilitate a process to parse in real time and to create a corresponding control instance. Therefore, the language or format of the DSL file may not be limited, as long as the process can parse the DSL file and render the target page described by the DSL file.

### 2) a Manner and Source of Obtaining the DSL File are not Limited in the Method Flow.

Optionally, the DSL file may be obtained locally or may be obtained externally. Specifically, a DSL file issued by a server-side or another device may be obtained.

Optionally, a body of executing the method flow may be a terminal application. To implement hot update of a page in the terminal application, a DSL file issued by a server-side corresponding to the terminal application may be obtained, where the DSL file may be configured for describing a latest version of target page, such that the terminal application may render the latest version of target page through the method flow, to implement the hot update of the page.

Optionally, the DSL file may also be obtained locally. Specifically, the DSL file may be a pre-downloaded DSL file, and when the target page needs to be displayed, the DSL file is obtained locally for rendering and displaying.

### 3) Regarding a Development Process for the Target Page.

The number of target pages is not limited in the method flow. Optionally, the target page may include one or more pages. Of course, the method flow may be interpreted as a process for rendering a single page, and a process for rendering other multiple pages may also be executed by using the method flow. The process for rendering other multiple pages may be obtained by a simple inference.

A manner of configuring the target page in the development process is not limited in the method flow.

The target page usually needs to be designed and configured by professional personnel, to publish or update the target page.

Optionally, the target page may be configured by a developer directly writing executable codes, or may be configured by a visualization platform.

The visualization platform may be configured for configuring page information according to an interaction operation of a user. A specific interaction operation and page information are not limited in this embodiment.

Optionally, configuration information of the page may include at least one of: control information (or information of a control), event information, or data information.

Optionally, the control information included in the page may be specifically configured, for example, control layout information, a control size, control content, etc. The event information and data information in the page may also be configured, for example, a jump event between different pages, an interaction event for a control, a transmission parameter data inside a page, etc. Specifically, event binding and data binding may be executed.

Optionally, the interaction operation of the professional personnel may include at least one of: a control dragging operation, an event binding operation, a data binding operation, a configuration operation, a control size adjustment operation, etc.

In a specific example, the professional personnel may execute an interactive operation for the visualization platform. The professional personnel first configures a size of an overall background panel of the page, and configures content of the background panel. Specifically, a picture may be configured. Then, the professional personnel may design an overall layout of the page by operations such as dragging the control, adjusting a position and a size of the control, etc. The professional personnel may also design an operation logic and a function of the page by binding an event and data.

In this embodiment, a development threshold of the professional personnel may be reduced through the visualization platform, and a convenience degree for operations of the professional personnel configuring the page may be improved.

### 4) Regarding a Manner of Generating the DSL File.

The manner of generating the DSL file is not limited in the method flow.

Optionally, the professional personnel may directly edit the DSL file for describe the target page.

For example, the DSL file may use pseudo codes, such that the professional personnel may edit the pseudo codes describing the page as the DSL file.

Optionally, the configuration information of the page may also be converted into the DSL file. Specifically, the configuration information of the page in the visualization platform may be used for conversion.

Optionally, the DSL file may be generated by: obtaining configuration information of the target page; and converting, based on a preset DSL conversion module, the configuration information into the DSL file.

In this embodiment, the configuration information of the target page may be automatically converted into the DSL file, improving an efficiency of generating the DSL file. Specific content of the configuration information is not limited in this embodiment.

Optionally, the configuration information may include at least one of: control information, event information, or data information. A specific form of the control information may not be limited.

Optionally, according to description of step S102 in the method flow, because the DSL file needs to be parsed and the control tree structure needs to be created, the configuration information may include information of the control tree structure. The configuration information may specifically include codes of each of control instances in the control tree structure and parent-child relationships between the control instances.

The information of the control tree structure may be generated according to a page configured by the visualization platform.

For example, the professional personnel may configure the target page through the visualization platform. Each of controls arranged in the target page may form a tree structure at a code level, such that codes of corresponding control instances are conveniently generated and are combined into codes of the control tree structure. The codes herein may specifically be executable codes.

A form of the DSL conversion module is not limited in this embodiment, as long as the DSL conversion module can convert the configuration information of the target page into a DSL file describing the target page.

In an optional embodiment, the codes of the control instances may be converted according to a control type (or the type of the control), to facilitate development of a DSL conversion module. Different conversion logics are developed for different control types.

Optionally, for each control type, the DSL conversion module may include a DSL control conversion sub-module corresponding to the each control type. The DSL conversion module may include one or more DSL control conversion sub-modules, and different DSL control conversion sub-modules may correspond to different control types.

Optionally, the DSL control conversion sub-module may be configured for converting codes for a control instance of the control type into DSL data describing the control instance of the control type.

In this embodiment, different conversion logics may be distinguished by the control type, reducing the development difficulty, and facilitating subsequent code update and check.

Certainly, in this embodiment, the control information in the configuration information of the page is mainly described, while the event information or data information may be separately converted by a DSL conversion module.

Specifically, the event binding information may be converted into DSL data describing an event binding situation, and the data binding information may be converted into DSL data describing a data binding situation.

Optionally, the DSL conversion module may be configured for synthesizing the DSL data converted by each of the conversion sub-modules to obtain a DSL file.

A specific logic for converting the configuration information of the target page into the DSL data is not limited in the method flow.

Optionally, for a control in the configuration information of the target page, information of the control may be converted into DSL data. Specifically, the conversion may be executed based on a template.

Optionally, different DSL format templates corresponding to different control types are preset, and for any one control in the configuration information, information of the control may be filled into a DSL format template corresponding to a type of the control, to obtain DSL data describing the control, that is, DSL data corresponding to the control.

Then, parent-child relationships, event binding information, data binding information, etc., between the controls may be synthesized to obtain the DSL file.

II. At Step S102: The Obtained DSL File is Parsed Based on a Preset DSL Parsing Module Such that a Control Tree Structure Including One or More Control Instances is Created, and then the Target Page is Rendered According to the Created Control Tree Structure.

Optionally, each of the control instances in the control tree structure may include: a rendering function and a DSL attribute.

Optionally, a value of the DSL attribute may include DSL data describing a control instance to which the DSL attribute belongs.

Optionally, the rendering function may be configured for rendering a corresponding control according to the current attribute value of the control instance to which the rendering function belongs, where the current attribute value is determined from the DSL data within the current value of the DSL attribute of the control instance to which the rendering function belongs.

### 1) Regarding Parsing the DSL File.

A manner of parsing the DSL file is not limited in the method flow.

Optionally, different types of DSL data in the DSL file may be parsed respectively, or the DSL file may be parsed uniformly.

Optionally, a preset DSL parsing module may be invoked for parsing.

In this embodiment, a source and form of the DSL parsing module are not limited, as long as the DSL file can be parsed by the DSL parsing module.

Optionally, the DSL parsing module may be issued by a server-side, or may be deployed locally on a device.

Optionally, the DSL parsing module may include a plurality of sub-modules, for parsing different types of DSL data in the DSL file respectively. The DSL parsing module may also include a plurality of branch logics for parsing the different types of DSL data in the DSL file respectively.

A situation of deploying the DSL parsing module is not limited in this embodiment. Optionally, the DSL parsing module may be deployed in a process, or may be deployed in a local storage area of the device, to facilitate invoking.

In an optional embodiment, a type of DSL data included in the DSL file is not limited in the method flow.

Optionally, because the DSL file is configured for describing the target page, and the page may usually include a control for display, an event, and data, the DSL file may include at least one of: control information, event information, or data information.

Optionally, when parsing the DSL file, the DSL parsing module may parse the control information, the event information, and the data information respectively, or may parse the control information, the event information, and the data information synthetically.

For the control information, optionally, controls displayed in the page include different control types, for example, a button, a text, an image, etc. Different control types may also correspond to different manners of parsing or results of parsing, for example, a type of the bound event may be different from a type of the bound data.

Therefore, different branch logics may be used to determine a control type and then parse the control type, or different parsing sub-modules may be used to parse different control types respectively.

Optionally, the DSL parsing module includes: a DSL control parsing sub-module that may correspond to the control type. The DSL control parsing sub-module may be configured for: parsing DSL data describing a control instance of the control type, to create a corresponding control instance.

Different DSL control parsing sub-modules may correspond to different control types. For each of the different DSL control parsing sub-modules, the DSL control parsing sub-module may be configured for: parsing DSL data describing a control instance of a corresponding control type, and creating a corresponding control instance.

Optionally, parsing the obtained DSL file based on a preset DSL parsing module may include: for DSL data describing a control instance of a target control type in the obtained DSL file, invoking a DSL control parsing sub-module corresponding to the target control type in the preset DSL parsing module to parse the DSL data.

In this embodiment, the DSL data describing the control instances of the control types in the DSL file may be parsed by a plurality of DSL control parsing sub-modules, and different conversion logics are distinguished by the control types, which reduces the development difficulty and facilitates subsequent code update and check.

A specific logic for converting the DSL data into the control instance is not limited in the method flow.

Optionally, DSL data corresponding to any one control instance in the DSL file may include information of a type of the control instance (or, control instance type) and information of an attribute value of a corresponding control, which may specifically have a fixed format (for example, a fixed field name and a corresponding value, a fixed data location, etc.). DSL data corresponding to different control instances of a same type may have a same format, to facilitate subsequent parsing the DSL data by the rendering function.

Optionally, the conversion may be executed based on a code template. Specifically, by presetting code templates for different control instances, the DSL data corresponding to any one control instance in the DSL file may be filled into a code template corresponding to the type of the control instance. Each of the code templates for control instances may include a DSL attribute and a rendering function. Specifically, the DSL data may be filled into the DSL attribute, such that a subsequent running of the rendering function may be facilitated by parsing the attribute value of the control from the DSL data and executing control rendering based on the value of the DSL attribute.

Therefore, the DSL parsing module may include a preset code template of a control instance, which may be specifically a template in a form of runnable codes.

Optionally, a code template of a control instance may correspond to a type of the control instance, and different control types may correspond to different code templates of control instances. A code template of a control instance may include a DSL attribute and a rendering function.

Optionally, when specifically parsing the DSL file based on the DSL parsing module, for DSL data corresponding to any one control instance in the DSL file, a template corresponding to a type of the control instance may be determined, and the DSL data is filled into a DSL attribute in the determined template, to create the control instance, which may be specifically a control instance in a form of runnable codes.

Certainly, in an optional embodiment, code templates of control instances for different types may include different attributes. For example, a code template of a control instance with a text type may include attributes, such as text content, a text font, etc.; and a code module of a control instance with an image type may include attributes such as an image resolution, etc.

Correspondingly, in code templates of control instances for different types, rendering functions may have different specific implementation logics, and may be specifically configured for implementing control attribute valuing and control rendering for types of control instances to which the rendering functions belongs.

### 2) Creating a Control Tree Structure Including One or More Control Instances.

A manner of creating the control tree structure is not limited in the method flow.

Optionally, the control tree structure including control instances may be created according to a result of parsing the DSL file.

Optionally, corresponding control instances may be created according to DSL data related to controls in the result of parsing the DSL file, and parent-child relationships between the control instances are determined, to obtain the control tree structure. The above explanation may be specifically referred to.

Optionally, the DSL data related to the controls in the result of parsing the DSL file may include control information nested according to the parent-child relationships between the controls, such that the corresponding control instances may be recursively created according to the DSL data related to the controls, and the parent-child relationships between the control instances is determined in a creation process, to obtain the control tree structure.

In an optional embodiment, the DSL file may include at least one of control information, event binding information, or data binding information describing the control tree structure.

Optionally, in the above method flow, before parsing the obtained DSL file, the method may further include the following steps: executing initialization to generate a data parsing processing module, an event parsing processing module, and a page generation module; saving the event binding information in the DSL file into the event parsing processing module; saving the data binding information in the DSL file into the data parsing processing module; and saving the control information in the DSL file into the page generation module.

Optionally, the DSL parsing module may include: a data parsing processing module, an event parsing processing module, and a page generation module.

In a subsequent parsing process, the data parsing processing module, the event parsing processing module, and the page generation module may respectively parse the saved information in the DSL file, to execute event binding, data binding, and creation of a control instance.

Optionally, creating a control tree structure including one or more control instances by parsing the obtained DSL file may include: invoking the page generation module, to parse the control information and create the control tree structure including the control instances

In the above embodiment, the control information, the event binding information, and the data binding information may be obtained by parsing with respective modules, which can effectively improve a parsing efficiency, and conveniently reduce the development difficulty.

The control instance is not limited in this method flow. Optionally, the control instance may include a widget that may specifically include a basic element widget (for example, a text, an image, a button, etc.) and a layout element widget (for example, Align, Stack, etc.).

In an optional embodiment, to facilitate subsequent page rendering and page dynamic updating, a control instance in the control tree structure may include a rendering function and a DSL attribute.

Optionally, each of the control instances in the control tree structure may include a rendering function and a DSL attribute.

The DSL attribute of a control instance may be configured for storing DSL data that currently describes the control instance, and the DSL data may be specifically in a form of json or in a form of key-value pair.

The rendering function of a control instance may be configured for parsing the DSL data within a value of the DSL attribute of the control instance, such that one or more attribute values (for example, a type, a size, a color, a transparency of the control instance, etc.) describing the control instance in the DSL data may be obtained, and then be further rendered and displayed.

Certainly, in this way, the DSL data within the value of the DSL attribute in the control instance can be easily updated, and after the updating is completed, the rendering function may re-executed for rendering and displaying, and thus dynamically updating the page.

Therefore, optionally, a value of the DSL attribute of a control instance may include DSL data describing the control instance. Optionally, the rendering function of a control instance may be configured for rendering a corresponding control according to a current attribute value of the control instance, where the current attribute value of the control instance is determined from the DSL data within the current value of the DSL attribute of the control instance.

Certainly, more specific explanation of the page rendering and page updating may refer to the following.

In addition, optionally, because the target page may include a plurality of pages, a correspondingly created control tree structure may include a plurality of control tree structures for respectively rendering different pages in the target page.

### 3) Rendering the Target Page.

In a case where a control tree structure including control instances is created, the target page may be rendered.

A specific manner of rendering the target page is not limited in the method flow.

Optionally, the target page may be rendered according to the created control tree structure.

Optionally, a corresponding control may be correspondingly rendered according to the created control tree structure, to render the target page.

Optionally, the rendering function in the control instance may also be executed, the DSL data within the value of the DSL attribute of the control instance may be parsed, and the corresponding control may be rendered to display the target page.

In an optional embodiment, for a control instance in the control tree structure, a corresponding control may be rendered by executing a rendering function in the control instance, to render the page.

The situation of executing the rendering function is not limited in this embodiment.

Optionally, the rendering function may be a construction function, such that the rendering function may be executed in a process of creating the control instance; or, the rendering function may not be a construction function, and needs to be invoked, such that the rendering function of the control instance in the control tree structure may be invoked when the target page needs to be rendered.

Optionally, the rendering function may include a construction function. Specifically, the rendering function may be the construction function, such that the construction function (that is, the rendering function) may be directly executed in a process of creating the control instance. Therefore, rendering the target page according to the created control tree structure may include: in a process of creating the control tree structure, executing the construction function in each of the control instances included in the control tree structure, to render corresponding controls and obtain the target page.

Optionally, rendering the target page may also include: in a process of creating the control instance, executing a construction function of the created control instance, and rendering a corresponding control to obtain the target page.

Optionally, in a specific process of rendering the target page, a construction function of each of control instances in the control tree structure may be executed, and corresponding controls may be rendered to obtain the target page.

In this embodiment, in a process of creating the control instance, the page may be directly rendered based on a characteristic of the construction function, improving rendering efficiency.

Optionally, when initialization of the target page is executed, the rendering function may also be invoked to render the page, and the initialization of the page may include initialization and updating of the control.

Therefore, optionally, rendering the target page according to the created control tree structure may include: executing an initialization event for the target page; determining a to-be-updated initial control instance and updating the DSL data in the determined initial control instance according to a result of executing the initialization event; and executing the rendering functions of the control instances in the control tree structure to render corresponding controls and obtain the target page.

The number of to-be-updated initial control instances is also not limited in this embodiment. Specifically, there may be no control instances, that is, there is no need to update the control instance; or there may be one or more control instances, such that the page may be rendered after updating the DSL data based on the initialization event.

A specific form of the initialization event is not limited in this embodiment. Optionally, the initialization event may include at least one of: an initial parameter obtaining event configured for obtaining an initial parameter of a page, a control updating event configured for updating a control of a page, a parameter updating event configured for updating a parameter of a page, etc.

Optionally, in a specific process of rendering the target page, a rendering function of each of control instances in the control tree structure may be executed, and corresponding controls may be rendered to obtain the target page.

It should be noted that because current rendering of the page is initialization-rendering, whether the control instance is updated may not be distinguished, and a rendering function of the control instance in the control tree structure may be directly executed to render the page.

In this embodiment, the page may be rendered by triggering and executing the rendering function in response to the initialization event for the target page, improving a stability of page rendering.

In an optional embodiment, because it may be necessary to update the page according to the initialization event for the target page, for example, according to the initialization event for the target page, it may be necessary to obtain real-time version update information from a server and check whether the version needs to be updated, for an embodiment in which the rendering function is the construction function, the page may be further updated according to the initialization event.

Optionally, the rendering function may specifically be a construction function, and rendering the target page may include: in a process of creating the control tree structure, executing the construction function in each of the control instances included in the control tree structure, to render corresponding controls and obtain the target page.

Further, the method flow may further include the following steps: executing an initialization event for the target page; determining a to-be-updated initial control instance and updating the DSL data in the determined initial control instance according to a result of executing the initialization event; and executing the rendering function of the updated initial control instance to update and render a corresponding control in the target page, and thus update the page.

In this embodiment, the page may be updated and rendered based on the initialization event, improving a page initialization efficiency and display effect.

### III. Updating of the Target Page.

The above embodiment explains steps of parsing the obtained DSL file, creating the control tree structure, and rendering the target page.

After the target page is rendered, optionally, layout or display in the target page may also need to be updated due to a service change, version update, etc., and then the target page needs to be updated and rendered. Of course, due to a situation of locally executing an event by the device, for example, needing to display a related result by a list when querying data, the layout or display in the target page may also need to be updated and the target page needs to be updated and rendered.

Optionally, at least one of the following items in the target page may be updated: event binding information, data binding information, or a control.

A specific manner of updating the target page and specific updating content of the target page are not limited in the method flow.

Optionally, event binding updating information may be obtained, to update the event binding information configured in the target page.

For example, for a page jump event, an event of jumping to a new page may be added as the new page is added.

Optionally, data binding updating information may be obtained, to update the data binding information configured in the target page.

For example, for a function updating button, a display text bound to the button may be updated.

In an optional embodiment, for a to-be-updated control in the target page, a corresponding control instance may be determined, DSL data in the control instance is updated, and a rendering function in the control instance is re-executed for updating, such that there is no need to update the target page entirely, improving updating efficiency and accuracy.

Specifically, to-be-updated controls in the target page may be updated only, and there is no need to update not-to-be-updated other controls in the target page.

Optionally, the above method flow may further include: updating the target page. Updating the target page may specifically include: obtaining control update data, determining a to-be-updated target control instance and updating the DSL data in the target control instance according to the obtained control update data; and executing the rendering function in the updated target control instance to render and update a control corresponding to the target control instance in the target page.

In this embodiment, DSL data in the control instance may be updated with the control update data to dynamically update the page, and the updating efficiency and accuracy may be improved by only updating the to-be-updated controls.

### 1) Regarding the Control Update Data.

A specific form and content of the control update data are not limited in this embodiment, as long as the to-be-updated target control instance can be determined according to the control update data, and the DSL data in the target control instance can be updated.

Optionally, the control update data may be in a form of DSL data or in a form of key-value pair.

Optionally, the control update data may include at least one of: information configured for representing the to-be-updated target control instance, information configured for representing a to-be-updated attribute of the control instance, information configured for representing a value result of the to-be-updated attribute of the control instance, etc.

Optionally, the control update data may include an identifier of the target control instance and to-be-updated new DSL data of the target control instance, such that a corresponding target control instance may be determined according to the identifier of the target control instance in the control update data, and then original DSL data in the target control instance is directly replaced with the new DSL data in the control update data.

Optionally, the control update data may include multiple groups of data in a form of key-value pair, and may specifically include an identifier of target control instance, a to-be-updated attribute, and a new value of the to-be-updated attribute. Therefore, the target control instance may be determined according to the identifier of target control instance in the control update data, and then, for the to-be-updated attribute in the control update data, the original value of the to-be-updated attribute in the target control instance is replaced with the new value of the to-be-updated attribute in the control update data.

A specific manner of updating the DSL data in the target control instance according to the control update data is not limited in this embodiment. Specifically, the determination may be executed according to content of the control update data.

Optionally, the control update data in the DSL form may be directly updated to the DSL data of the target control instance.

Optionally, for the control update data in a form of key-value pair, an attribute in the target control instance may be determined according to the key in the control update data, and then updated to the value of the attribute in the control update data.

A manner of obtaining the control update data is not limited in this embodiment.

Optionally, the control update data may be obtained from other devices, or may be obtained locally.

Optionally, the control update data may be obtained from the server-side. For example, the server-side stores the latest version of page with updated services, such that the latest version of page may be issued to the terminal for page updating.

Optionally, the control update data may also be obtained from a local event execution result. For example, after data is locally queried to obtain a result, a list control is updated and displayed.

Therefore, optionally, a body of executing the method flow may be a terminal, and the terminal may correspond to a server-side. Specifically, the terminal may correspond to the server-side in terms of services. The terminal may be specifically a client.

Optionally, obtaining the control update data may include: obtaining the control update data according to a local event execution result; and/or obtaining the control update data sent by an external device.

The external device is not limited in this embodiment. The external device may be specifically the server-side corresponding to the terminal. Therefore, correspondingly, obtaining the control update data may include: obtaining the control update data according to an event execution result in the terminal; and/or, obtaining control update data issued by a server-side corresponding to the terminal.

Optionally, obtaining the control update data may include: obtaining the control update data according to an event execution result in the client; and/or, obtaining control update data issued by a server-side corresponding to the client.

In this embodiment, the control update data may be obtained through the local event execution result of the terminal, or the control update data is obtained from the server-side corresponding to the terminal, such that the flexibility of obtaining the control update data is improved, and the updating of the control is more suitable for the services.

In an optional embodiment, to facilitate the reduction of the development cost, when configuring the updated page, visual page configuration update may be utilized such that, based on a principle of generating the DSL file, the visual page configuration update is converted into DSL data in the DSL form by a DSL conversion module and then the DSL data is taken as the control update data.

Optionally, the control update data may be generated by: obtaining attribute update information of a to-be-updated control; and converting, based on a preset DSL conversion module, the attribute update information into the control update data in a DSL form.

A manner of obtaining the attribute update information of the to-be-updated control is not limited in this embodiment.

Optionally, the attribute update information of the to-be-updated control may be obtained according to a local event execution result of the body of executing; or the attribute update information of the to-be-updated control may be determined based on visual page configuration update; or the attribute update information of the to-be-updated control in a form of key-value pair may be obtained from the server-side.

Optionally, the method of generating the control update data may be executed by an external device or locally, which is not limited in this embodiment.

The attribute update information is converted into the control update data in a DSL form, such that the DSL data in the control may be updated conveniently, and the updating efficiency is improved.

A specific manner of updating is not limited in this embodiment.

Optionally, in a case where the control update data includes only the attribute update information, data of the corresponding attribute in the DSL data of the to-be-updated control instance may be replaced with the control update data; and in a case where the control update data includes all DSL data of the to-be-updated control, the DSL data of the to-be-updated control instance may be directly replaced with the control update data.

In this embodiment, the attribute update information may be uniformly converted, by the DSL conversion module, into data in a DSL form, improving the updating efficiency of the control.

### 2) Regarding the Situation of Executing the Rendering Function.

A manner of executing the rendering function is not limited in the method flow.

Optionally, because the rendering function needs to be re-executed for updating and rendering, the rendering function in the control instance may be directly invoked, and the control rendering may be executed, to render and update the page.

Optionally, in a case where the rendering function is a construction function, the construction function may be re-executed for updating and rendering. Specifically, the construction function may be first executed, and then the construction function is re-executed.

Optionally, in a case where the rendering function is not the construction function, the rendering function may also be directly invoked to re-execute the control rendering.

In an optional embodiment, for each of the control instances, a state instance for invoking and executing the rendering function in the control instance may be created, such that updating and rendering the control instance is controlled by the state instance indirectly.

Optionally, the method flow may further include: creating a corresponding state instance for the each control instance; where different control instances correspond to different state instances, and each of the state instances is enabled to execute the rendering function in a corresponding control instance.

Optionally, executing a rendering function in the updated target control instance may include: invoking a state instance corresponding to the target control instance to execute the rendering function in the updated target control instance.

Optionally, in a flutter scenario, the control instance may be a widget; the state instance may be a corresponding state and may be specifically a state configured as a common state, such that the state may be conveniently invoked to execute a rendering function of a corresponding widget.

Optionally, different control instances may correspond to different state instances.

In this embodiment, the rendering function of the corresponding control instance may be indirectly executed through the state instance, improving a security of executing the rendering function.

Further, optionally, the status instance may be further configured for updating DSL data in the corresponding control instance, such that the status instance may execute an overall update flow for the corresponding control instance.

Optionally, each of the state instances may be further configured for updating a value of the DSL attribute in the corresponding control instance; updating DSL data in the target control instance may include invoking the state instance corresponding to the target control instance to update the DSL data in the target control instance with the control update data.

In this embodiment, the DSL data of the corresponding control instance may be updated through the state instance, improving a security of updating the DSL data.

### IV. Event.

In the method flow, there may be a plurality of events for the rendered target page, for example, a page jump event, a query event, a data obtaining event, etc.

A specific form of the event and a condition of triggering the event are not limited in the method flow.

Optionally, for an event triggered by a control operation, to facilitate overall management, a root node may be configured as a notification center for a control tree structure, to facilitate searching for control information triggered by the operation, and facilitate sending related information triggered by the operation to an event processing module.

Optionally, a root node of the control tree structure may include a notification center control instance; where the notification center control instance may be configured for: in response to receiving a control interaction event, sending information of an interacted control instance to an event parsing processing module, and triggering the event parsing processing module to execute a corresponding operation event and obtain an event execution result; the event parsing processing module may include a set of correspondences between information of the control instances and operation events.

A form of the root node of the control tree structure and a manner of creating the root node are not limited in this embodiment. Optionally, after the control tree structure is determined according to the created control instance, for a current root node, a parent node may be further added as a new root node, and the new root node is configured as a notification center.

A form of a control interaction event is not limited in this embodiment, for example, clicking a button, double-clicking the button, clicking a picture etc.

A form of information of the control instance is not limited in this embodiment. Optionally, the information of the control instance may include at least one of: an identifier of the control instance, a type of the control instance, an interaction type, an operation type, etc.

For ease of understanding, for example, the information of the control instance may be configured for representing clicking a “query” button, double-clicking a “specified” icon.

A specific form of the event parsing processing module is not limited in this embodiment. Optionally, the event parsing processing module may be configured for parsing the information of the control instance, determining a corresponding operation event, and executing the corresponding operation event, to obtain an event execution result.

In a specific embodiment, the interacted control may be a query button, and the notification center control instance may send information of the query button to the event parsing processing module.

The event parsing processing module may include correspondences between query buttons and data query operations, such that a corresponding data query operation may be executed based on interaction with the query button, and the table control is further updated according to the event execution result, to display a query result.

In this embodiment, by configuring the root node of the control tree structure as the notification center, the corresponding control instance may be quickly determined for the control interaction event, conveniently improving the efficiency of processing the control interaction event.

Corresponding to the above page rendering method of executing actual page rendering, embodiments of the present disclosure further provide other page rendering methods. Specifically, the methods may be a method of generating a DSL file to render a page, and a page rendering method integrating both ends.

As shown in FIG. 2, FIG. 2 is another schematic flowchart of a page rendering method shown according to an embodiment of the present disclosure. The method may be applied to a development end. The development end may be specifically a terminal operated by a developer.

This method may include the following steps S201˜S202.

At step S201, configuration information of a target page is obtained.

Optionally, the configuration information may include information of a control tree structure.

At step S202, the obtained configuration information is converted into a domain-specific-language (DSL) file describing the target page based on a preset DSL conversion module.

Optionally, a result of parsing the DSL file may be configured for creating the control tree structure including one or more control instances; and the created control tree structure is configured for rendering the target page.

Optionally, each of the control instances in the control tree structure may include: a rendering function and a DSL attribute.

Optionally, for each control instance of the control instances in the control tree structure, a value of the DSL attribute of the each control instance may include DSL data describing the each control instance, and the rendering function of the each control instance may be configured for rendering a corresponding control according to a current attribute value of the each control instance which is determined from the DSL data within a current value of the DSL attribute of the each control instance.

In the method flow, the converted DSL file may be configured for, after being parsed, creating the control tree structure including the control instances, such that subsequent target page rendering is facilitated, and the target page can also be rendered in real time by parsing the DSL file, improving the flexibility of rendering the page.

In addition, the method flow may be specifically applied to a development platform, and the development platform may specifically be a visual page configuration platform, conveniently executing the development through visual configuration of a page. Therefore, the DSL file generated by the development end may be conveniently parsed in real time for rendering when the target page is rendered, improving the flexibility of rendering the page.

How to store the converted DSL file is not limited in the method flow.

Optionally, the development end may upload the DSL file to the server-side, such that the terminal that needs to render the target page obtains the DSL file from the server-side for parsing and rendering.

Specifically, the DSL file and a preset DSL parsing module may be packaged into a program package and the program package may be stored in the server-side. The terminal may download the program package from the server-side, and render the target page by parsing and running the program package.

Other explanation of the method flow may refer to the above description.

As shown in FIG. 3, FIG. 3 is another schematic flowchart of a page rendering method shown according to an embodiment of the present disclosure.

The method may include steps executed by the development end and steps executed by the rendering end. The development end may be specifically a terminal operated by a developer. The rendering end may be a terminal specifically rendering the target page, for example, an application terminal.

This method may include the following steps S301˜S303.

At step S301, a development end obtains configuration information of a target page.

Optionally, the configuration information may include information of a control tree structure.

At step S302, the development end converts the configuration information into a domain-specific-language (DSL) file describing the target page based on a preset DSL conversion module.

At step S303, a rendering end obtains the DSL file, creates a control tree structure including one or more control instances by parsing the obtained DSL file based on a preset DSL parsing module, and renders the target page according to the created control tree structure.

Optionally, each of the control instances in the control tree structure may include: a rendering function and a DSL attribute.

Optionally, for each control instance of the control instances in the control tree structure, a value of the DSL attribute of the each control instance may include DSL data describing the each control instance, and the rendering function of the each control instance may be configured for rendering a corresponding control according to a current attribute value of the each control instance which is determined from the DSL data within a current value of the DSL attribute of the each control instance.

In the method flow, the rendering end may obtain the converted DSL file for subsequent parsing and target page rendering, such that the target page may be rendered in real time by parsing the DSL file, improving the flexibility of rendering the page.

How the rendering end obtains the DSL file is not limited in the method flow.

Optionally, the development end may upload the DSL file to the server-side, such that the rendering end that needs to render the target page obtains the DSL file from the server-side for parsing and rendering.

Specifically, the DSL file and a preset DSL parsing module may be packaged into a program package and the program package may be stored in the server-side. The rendering end may download the program package from the server-side, and render the target page by parsing and running the program package.

Other explanation of the method flow may refer to the above description.

For ease of understanding, an embodiment of the present disclosure further provides an application embodiment.

Explanations of several concepts is firstly given.

Flutter: the Flutter is a cross-platform framework.

Widget: each of UI components in a Flutter framework is a widget, for example, a text, an image, a button, etc.

State: the State is a state of a widget. Widget initialization generates a corresponding state for updating a display state and data of the widget.

DSL: the domain-specific-language (DSL) is a language intended for context in a particular domain. The DSL may take the form of JSON in this embodiment.

Microprogram: the microprogram is a service module with dynamic generation and hot update. A function module composed of as small as one page or as large as a plurality of pages may be referred to as a microprogram.

Dart: the Dart is a Flutter development language, and is in a Flutter code file format.

WidgeID: the WidgeID is a unique ID of each widget.

JsonPath: the JsonPath is a path of a certain field in a Json tree structure. As shown in FIG. 3, JsonPath of a color field is “$ [‘style’][‘color’]”.

EventCenter: the EventCenter is an event parsing processing module.

DataCenter: the DataCenter is a data parsing processing module.

Init: the Init is a page initialization event. The page initialization even is a process of obtaining data entering the page and rendering the page.

Click: the Click is a click event of a user.

With development of electronic technologies and Internet of Things, performances of terminal devices (mobile devices, display devices, TVs, etc.) are becoming more and more powerful, and various platforms need to interact with each other, which directly results in that package volumes of terminal application programs become larger and larger (high-definition images, various 3D engines, etc.).

Different from Web application programs, since the terminal application may be deployed in a cloud, the hot update and the version update form a great pain point.

For a Flutter cross-platform development scheme, application programs developed according to the framework may be run by multiple platform terminal devices with iOS, Android, Web, and Windows. However, the Flutter does not have a dynamic page generation capability similar to the Web.

In this embodiment, a capability of dynamically cross-platform generating a page may be achieved by parsing a basic element, widget, of the Flutter, based on a cross-platform characteristic of the Flutter. Specifically, the terminal application may be packaged, by parsing the basic element of the Flutter into a DSL intermediate language based on the cross-platform characteristic of the Flutter, and then parsing the DSL intermediate language into an executable file by each of platform terminals.

The principle of the Flutter cross-platform is the following.

The Flutter architecture uses a hierarchical design, and includes three layers from bottom to top, which are an Embedder, an Engine, and a Framework in sequence.

The Embedder is an operating system adaptation layer, and implements adaptation of platform related characteristics, such as rendering surface settings, thread settings, platform plug-ins, etc. It can be seen here that there are not many related characteristics of the Flutter platform, which makes costs of maintaining a cross-end consistency at a framework level relatively low.

The Engine layer mainly includes Skia, Dart, and Text, which implements functions, such as rendering engine, text typesetting, event processing, Dart runtime, etc., of the Flutter. The Skia and Text provide an upper layer interface with an ability to invoke rendering and typesetting on a bottom layer, and the Dart provides the Flutter with an ability to invoke the Dart and rendering engine by the runtime. A function of the Engine layer is to combine them and implement view rendering from data generated by them.

The Framework layer is a UI SDK implemented by Dart, and includes functions such as animation, graphic drawing, gesture recognition, etc. To provide a more intuitive and more convenient interface when drawing fixed style graphics such as controls, etc., the Flutter also encapsulates a set of UI component libraries according to two visual design styles of Material and Cupertino based on these basic capabilities. We may directly use these component libraries when developing the Flutter.

Briefly, the Flutter encapsulates the upper layer UI through the rendering on the bottom layer of the system to achieve a cross-platform UI consistency.

Based on this, this embodiment develops a dynamic framework to implement dynamic generation and update (named as a microprogram) of a Flutter page. This embodiment is described in detail below from several aspects, such as a UI page, data binding, event binding, etc.

### I. Microprogram Page DSL Composition and Parsing.

A DSL description file of a microprogram page may be mainly divided into 4 parts.
1) A Layout field represents layout of an overall page, i.e., sizes, locations, and default data of various components.
2) An Events field represents an event description set of the overall page. Each of events uses a WidgetID as a key, and includes EventParameters-event parameter, TargetWidget-target widget, for subsequent EventCenter parsing and event execution.
3) A Parameters field represents initialization parameters of the page and transmission parameters of the page jump, in a form of key-value, which is saved in DataCenter parsing and storage, to represent in-parameters when executing the page initialization event.
4) An Other field represents some other fields and includes a unique ID, a title, a routing name, etc., of the page, which are configured for page routing and jump.

In normal development of a Flutter program, service dart files need to be created and to be statically compiled into a program package.

If a page is to be dynamically generated, the page needs to be dynamically generated according to a page description (DSL) requested by a network when a program (dart file) runs. Therefore, the dart file cannot be deployed to be issued by the cloud. The dart file needs to be converted into a DSL file and the DSL file is uploaded to the cloud, then the cloud issues the DSL file to the program through the network, and then the DSL file is converted into the page inside the Dart.

Interfaces of a terminal application are nothing more than an aggregation of texts, images, buttons, input boxes, and lists, while layout on the Flutter end is a tree structure.

For example, a login page uses a Container as a root node and child nodes as a Column (column), and the child nodes of the column are a Text (BOE), a Text (welcome to use an intelligent refrigerator management system), a Button (login), etc. An input box is a Row (row), and the child nodes are a TextField (input box), a Button (close button).

The dynamic generation of the microprogram page needs to put the above page with the tree structure into the cloud (similar to the Web). A storage form of the page, an issuing form of the page, and a runtime parsing generation process after issuing need to use a DSL dynamic parsing framework (or the DSL dynamic framework) in this embodiment.

A core of the DSL dynamic framework includes the following 6 modules.

1. Widget to DSL: A Widget is Parsed into a DSL Object, which is an Export Method.

Each of widgets corresponds to an export method, and is responsible for converting each of attributes into a DSL object and storing the DSL object into a Parser parsing pool.

A single text is taken as an example, the overall text widget is converted into a DSL object by parsing each of attributes of the text.

2. DSL to Widget: The DSL Object is Parsed into a Corresponding Widget, which is a Parser Method.

Each of the widgets corresponds to a Parser method, and is responsible for converting the DSL object into each of attributes of the Widget, and storing the attributes into the Parser parsing pool.

### 3. Parser Parsing Pool: The Parser Parsing Pool is a Set of Parser Parsers of all Widgets of DSL. a Type is Used as the Key, and is Searched for According to a Type Field in the DSL in the Parsing Process.

### 4. Build Method: The Build Method is a Main Method of the Page Dynamic Generation Process.

According to the DSL file, all nodes are recursively traversed from a root node of a widget tree for the DSL file. A parser for a type of a node is found in the Parser parsing pool according to the type of the node for parsing to obtain a corresponding widget instance. Then child (or children) nodes of the node continue to be traversed. According to a type of a child node, a parser for the node is found to continue parsing to obtain a widget instance, until the last layer of the widget tree. So far, a widget tree of the entire page is generated and rendered.

Correspondingly, for a page configured in a development process, all nodes may be recursively traversed from a root node according to a widget tree in the page, and conversion is executed by using an export method, to obtain DSL data that can represent the widget tree.

5. EventCenter: the EventCenter is an event center of a page, and is an aggregation of a page initialization event and user interaction behaviours for the runtime. Storage is executed in a form of key-value. The key is WidgetID, and the value is an event description set.
6. DataCenter: the DataCenter is a data center of a page. Page initialization data and data generated by the runtime are stored in a form of key-value. The key is WidgetID, and the value is a data set including data requested by a network and DSL data of widget.

### II. Widget Data Binding and Parsing

After the UI page in the above first step is completed, the page has the capability of rendering and displaying static data. However, in an actual service, the page displays dynamic data. For example, a list obtains data from a server-side through a network request and displays the data.

If the microprogram page is to display the dynamic data, a capability of dynamically obtaining data needs to be given to each of widgets. Based on this, a base class DSLBaseWidget is designed in this embodiment.

The DSLBaseWidget includes a jsonMap attribute and a setCustom Widget method.

JsonMap saves DSL data description of an incoming parameter, widget.

SetCustom Widget is a method of constructing the widget.

Other widgets include an inheritance DSLBaseWidget, such as a text, an image, etc., and the method of constructing the widget is rewritten, that is, a setCustom Widget method, to generate an instance of each of widgets.

In a process of generating an instance, a state instance of each of the widgets is saved in the DataCenter, and when an event points to a widget update, the DataCenter extracts a state according to a WidgetID, injects event result data into the jsonMap, the state executes an update operation, and the setCustom Widget is re-executed to refresh the widget.

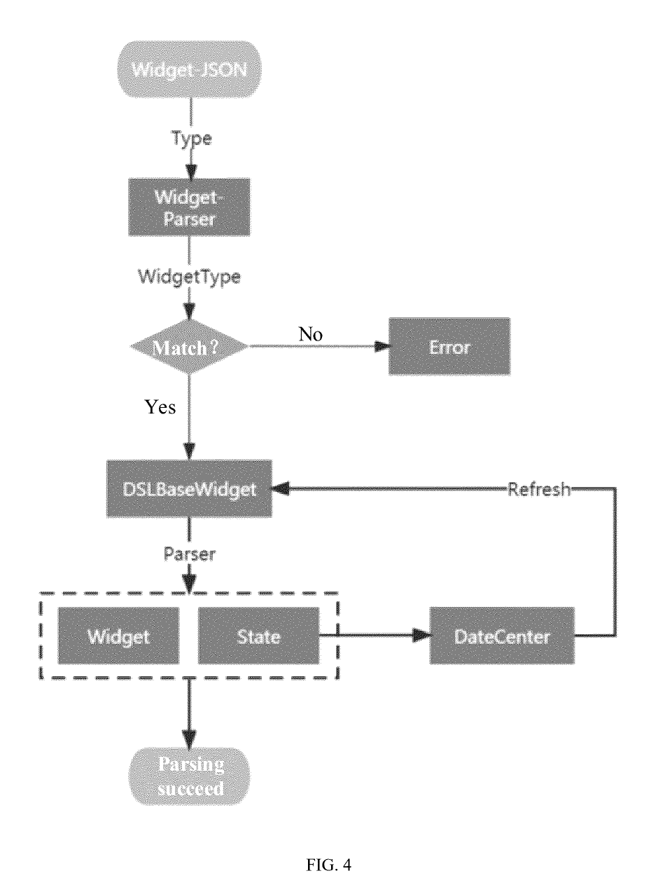

As shown in FIG. 4, FIG. 4 is a schematic principle diagram of a page updating method shown according to an embodiment of the present disclosure.

### III. Microprogram Event Bus.

After recursive parsing of the microprogram page is completed, the root node is configured as a NotificationWidget to receive an interaction event of a user, and when the user clicks a button or a picture, a notification of the event bus is triggered. The notification transparently transmits the DSL data of the widget, and the EventCenter searches for event description and an event parameter according to the WidgetID, and executes a corresponding event. The page is refreshed after the execution is completed.

### IV. Runtime.

### 1. Data Stack.

Data variables generated during parsing and execution of the DataCenter and EventCenter, such as a data source of List and Response data requested by the network, are stored in the form of key-value in the data Stack. The key is WidgetID and the value is a data source generated during the parsing and execution, which facilitates to invoke event parameters.

### 2. Data Refresh.

The event description of each of the events includes an ID and a target attribute of the TargetWidget. After the execution of the event is completed, the data result is updated to jsonMap of the target widget, then the state of the target widget is searched for from the DataCenter, and an update operation is executed.

### V. Whole Process Flow.

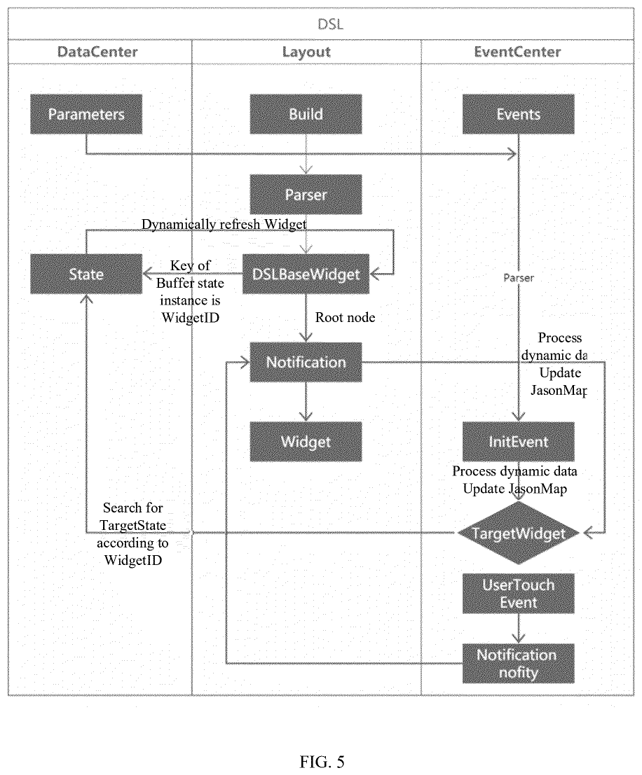

For ease of understanding, as shown in FIG. 5, FIG. 5 is a schematic flowchart of a page rendering and updating method shown according to an embodiment of the present disclosure, which specifically represents a dynamic parsing and data refreshing process of a microprogram page.
1. The DataCenter, EventCenter, Layout objects are initialized and JSON data is received. The DataCenter saves a parameter set, the EventCenter saves an event description set, and the Layout saves UI page description.
2. The Layout is parsed into a widget tree by recursively invoking a Build method, and a root node is configured as a notification center NotificationWidget for data penetration of an event bus. Each of widget nodes generates a corresponding state, and saves the state and JSON data of the node to the DataCenter according to the WidgeID.
3. The EventCenter executes an InitEvent (page initialization) event.
4. The TargetState and JSON data are searched for according to the Widget ID of the TargetWidget, the result data of executing the InitEvent event is injected into the JSON data of the TargetWidget, and the refresh method of the state is invoked to update and render the TargetWidget to complete the initialization of the page.
5. The event clicked by the user is transparently transmitted to the Layout page through the notification event bus, the event description is searched for from the EventCenter according to the EventID, and the EventCenter executes the corresponding event. If the event result needs to update the widget, the TargetState and JSON data are searched for according to the WidgeID of the TargetWidget, the result data of executing the InitEvent event is injected into the JSON data of the TargetWidget, and a refresh method of the state is invoked to update and render the TargetWidget.

### VI. Overall Product.

Product generation layer: a Flutter designer (visual configurator) configures page UI layout, respective widget data binding, and event binding, and generates DSL products of microprograms.

Product hosting layer: a microprogram package is stored in the cloud.

Product running layer: the terminal obtains the microprogram package from the cloud, generates an executable file through a DSL parser of the terminal, and runs the executable file.

Taking a software application open platform as an example, there are mainly three steps.

### 1. Visual Configurator Panel.

The visualization panel may drag each of widgets (a text, an image, etc.) according to a service requirement to generate the entire page.

The attribute of each of the widgets, such as font, color, etc., may be adjusted according to a UI graph.

A login interface and a page jump event are configured for a login button.

### 2. A DSL Page Product of a Microprogram is Generated.

After the overall page configuration is completed, an export method of a current widget and sub-widgets is recursively executed according to the type to generate a DSL product of the overall page.

### 3. An App Package for the Terminal is Generated by a Jenkins Packaging Tool, and the Terminal Installs and Runs the App Package.

### 4. Microprogram DSL Page Terminal Parsing.

After obtaining the DSL, the terminal recursively executes a Build method parsing, to generate an executable file.

In this embodiment, the following may be implemented: 1. dynamic page generation of multiple platform terminals, including platform terminals, such as iOS, Android, and windows. 2. free page layout and visual configuration with low granularity; 3. dynamically binding data and events of a terminal page and App hot update; and 4. an entire low code scheme flow.

Corresponding to the above method embodiments, an embodiment of the present disclosure further provides an apparatus embodiment.

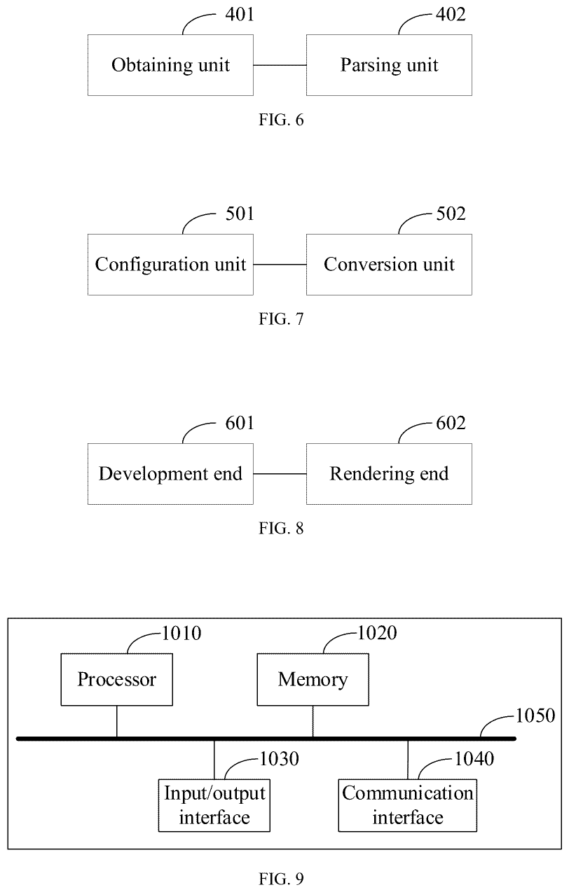

As shown in FIG. 6, FIG. 6 is a schematic structural diagram of a page rendering apparatus shown according to an embodiment of the present disclosure.

The apparatus may include an obtaining unit 401 and a parsing unit 402.

The obtaining unit 401 is configured for obtaining a domain-specific-language (DSL) file describing a target page. The target page may include one or more controls.

The parsing unit 402 is configured for creating a control tree structure including one or more control instances by parsing the obtained DSL file based on a preset DSL parsing module, and rendering the target page according to the created control tree structure.

Optionally, each of the control instances in the control tree structure includes: a rendering function and a DSL attribute.

Optionally, for each control instance of the control instances in the control tree structure, a value of the DSL attribute of the each control instance includes DSL data describing the each control instance, and the rendering function of the each control instance is configured for rendering a corresponding control according to a current attribute value of the each control instance which is determined from the DSL data within a current value of the DSL attribute of the each control instance.

Optionally, the apparatus further includes an update unit 403 configured for updating the target page; and the updating the target page specifically includes: obtaining control update data, determining a to-be-updated target control instance and updating the DSL data in the target control instance according to the obtained control update data; and executing the rendering function in the updated target control instance to render and update a control corresponding to the target control instance in the target page.

Optionally, the parsing unit 402 is further configured for: creating a corresponding state instance for the each control instance; where different control instances correspond to different state instances, and each of the state instances is enabled to execute the rendering function in a corresponding control instance;
the update unit 403 is configured for:
invoking a state instance corresponding to the target control instance to execute the rendering function in the updated target control instance.

Optionally, each of the state instances is further configured for updating a value of a DSL attribute in the corresponding control instance;
the update unit 403 is configured for:
invoking the state instance corresponding to the target control instance to update the DSL data in the target control instance according to the control update data.

Optionally, the update unit 403 may further be configured for:
obtaining the control update data according to a local event execution result; and/or
obtaining the control update data sent by an external device.

Optionally, a root node of the control tree structure includes a notification center control instance;
the notification center control instance is configured for: in response to receiving a control interaction event, sending information of an interacted control instance to an event parsing processing module, and triggering the event parsing processing module to execute a corresponding operation event and obtain an event execution result;
the event parsing processing module includes a set of correspondences between information of the control instances and operation events.

Optionally, the control update data is generated by:
obtaining attribute update information of a to-be-updated control; and
converting, based on a preset DSL conversion module, the attribute update information into the control update data in a DSL form.

Optionally, the DSL file is generated by:
obtaining configuration information of the target page, where the configuration information includes information of the control tree structure; and
converting, based on a preset DSL conversion module, the configuration information into the DSL file.

Optionally, the DSL file includes at least one of control information, event binding information, or data binding information describing the control tree structure;
the parsing unit 402 is further configured for:
executing initialization to generate a data parsing processing module, an event parsing processing module, and a page generation module;
saving the event binding information in the DSL file into the event parsing processing module;
saving the data binding information in the DSL file into the data parsing processing module;
saving the control information in the DSL file into the page generation module; and
invoking the page generation module, to parse the control information and create the control tree structure including the control instances.

Optionally, the parsing unit 402 is configured for:
executing an initialization event for the target page;
determining a to-be-updated initial control instance and updating the DSL data in the determined initial control instance according to a result of executing the initialization event; and
executing the rendering function in each of the control instances in the control tree structure to render corresponding controls and obtain the target page.

Optionally, the rendering function includes a construction function; and the parsing unit 402 is configured for:
in a process of creating the control tree structure, executing the construction function in each of the control instances included in the control tree structure, to render corresponding controls and obtain the target page.

Optionally, the parsing unit 402 is further configured for:
executing an initialization event for the target page;
determining a to-be-updated initial control instance and updating DSL data in the determined initial control instance according to a result of executing the initialization event; and
executing the rendering function in the updated initial control instance to update and render a corresponding control in the target page.

Optionally, for each control type, the DSL parsing module includes: a DSL control parsing sub-module corresponding to the each control type;
the DSL control parsing sub-module is configured for: parsing DSL data describing a control instance of the control type, and creating a corresponding control instance;
the parsing unit 402 is configured for:
for DSL data describing a control instance of a target control type in the obtained DSL file, invoking a DSL control parsing sub-module corresponding to the target control type in the preset DSL parsing module to parse the DSL data.

Optionally, for each control type, the DSL conversion module includes a DSL control conversion sub-module corresponding to the each control type;
the DSL control conversion sub-module is configured for converting codes for a control instance of the control type into DSL data describing the control instance of the control type.

The specific explanation may refer to the above method embodiments.

As shown in FIG. 7, FIG. 7 is another schematic structural diagram of a page rendering apparatus shown according to an embodiment of the present disclosure.

The apparatus may include a configuration unit 501 and a conversion unit 502.

The configuration unit 501 is configured for obtaining configuration information of a target page, where the configuration information may include information of a control tree structure.

The conversion unit 502 is configured for converting the configuration information into a DSL file describing the target page based on a preset DSL conversion module.

Optionally, a result of parsing the DSL file may be configured for creating the control tree structure including one or more control instances; and the created control tree structure is configured for rendering the target page.

Optionally, each of the control instances in the control tree structure may include: a rendering function and a DSL attribute.

Optionally, for each control instance of the control instances in the control tree structure, a value of the DSL attribute of the each control instance may include DSL data describing the each control instance, and the rendering function of the each control instance may be configured for rendering a corresponding control according to a current attribute value of the each control instance which is determined from the DSL data within a current value of the DSL attribute of the each control instance.

The specific explanation may refer to the above method embodiments.

As shown in FIG. 8, FIG. 8 is a schematic structural diagram of a page rendering system shown according to an embodiment of the present disclosure.

The system may include a development end 601 and a rendering end 602.

The development end 601 may be configured for: obtaining configuration information of a target page, where the configuration information may include information of a control tree structure; and converting the configuration information into a domain-specific-language (DSL) file describing the target page based on a preset DSL conversion module.

The rendering end 602 may be configured for: obtaining the DSL file, creating the control tree structure including one or more control instances by parsing the obtained DSL file based on a preset DSL parsing module, and rendering the target page according to the created control tree structure.

Optionally, each of the control instances in the control tree structure may include: a rendering function and a DSL attribute.

Optionally, for each control instance of the control instances in the control tree structure, a value of the DSL attribute of the each control instance may include DSL data describing the each control instance, and the rendering function of the each control instance may be configured for rendering a corresponding control according to a current attribute value of the each control instance which is determined from the DSL data within a current value of the DSL attribute of the each control instance.

The specific explanation may refer to the above method embodiments.

An embodiment of the present disclosure further provides a computer device. The computer device at least includes a memory, a processor, and a computer program stored in the memory and runnable by the processor. The processor, when executing the computer program, implements the above any one method embodiment.

An embodiment of the present disclosure further provides an electronic device, including: at least one processor and a memory connected communicatively to the at least one processor, where the memory stores instructions that are executable by the at least one processor, and the instructions are executed by the at least one processor, such that the at least one processor can execute the above any one method embodiment.

FIG. 9 is a schematic diagram of a hardware structure of a computer device for configuring the method of an embodiment of the present disclosure, shown according to an embodiment of the present disclosure. The device may include: a processor 1010, a memory 1020, an input/output interface 1030, a communication interface 1040, and a bus 1050. The processor 1010, the memory 1020, the input/output interface 1030, and the communication interface 1040 implement communication connections with each other inside the device through the bus 1050.

The processor 1010 may be implemented in various manners, such as a general-purpose central processing unit (CPU), a microprocessor, an application specific integrated circuit (ASIC), one or more integrated circuits, etc., and may be configured for executing related programs to implement the technical solutions provided in the embodiments of the present disclosure.

The memory 1020 may be implemented in a form of a ROM (read only memory), an RAM (random access memory), a static storage device, a dynamic storage device, etc. The memory 1020 may store an operating system and other application programs. When implementing the technical solutions provided in the embodiments of the present disclosure by software or firmware, related program codes are saved in the memory 1020 and invoked and executed by the processor 1010.

The input/output interface 1030 is configured for being connected to an input/output module to implement information input and output. The input/output module may be used as a component configured in the device (not shown in figures), or may be externally connected to the device to provide a corresponding function. The input device may include a keyboard, a mouse, a touch screen, a microphone, various sensors, etc., and the output device may include a display, a speaker, a vibrator, an indicator light, etc.

The communication interface 1040 is configured for being connected to a communication module (not shown in the figures), to implement communication interaction between the device and other devices. The communication module may implement the communication in a wired manner (for example, a USB, a network cable, etc.), or may implement the communication in a wireless manner (for example, a mobile network, a WIFI, a Bluetooth, etc.).

The bus 1050 includes a path to transmit information between various components (for example, the processor 1010, the memory 1020, the input/output interface 1030, and the communication interface 1040) of the device.

It should be noted that although the above device only includes the processor 1010, the memory 1020, the input/output interface 1030, the communication interface 1040, and the bus 1050, in a specific implementation process, the device may further include other components necessary to implement a normal running. In addition, those skilled in the art may understand that the above device may only include components necessary to implement the solutions of the embodiments of the present disclosure, and does not necessarily include all components shown in the figures.

An embodiment of the present disclosure provides further a computer-readable storage medium, storing a computer program. A processor, when executing the computer program, implements the above any one method embodiment.

An embodiment of the present disclosure provides further a computer-readable storage medium, storing a computer program. A processor, when executing the computer program, implements the above any one method embodiment.

The computer-readable medium includes permanent and non-permanent, removable and non-removable media, in which information storage may be implemented by any method or technology. The information may be computer-readable instructions, data structures, modules of programs, or other data. Examples of the computer storage medium include, but are not limited to, a phase change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital multi-function optical disk (DVD) or other optical storage, a magnetic cartridge tape, a magnetic disk storage, or other magnetic storage devices or any other non-transmission medium. The computer storage medium may be configured for storing information that may be accessed by the computing device. According to the definition herein, the computer-readable medium does not include the transitory storage computer-readable media, such as modulated data signals and carriers.

From the above description of the implementations, those skilled in the art may clearly understand that the embodiments of the present disclosure may be implemented by means of software and the necessary universal hardware platform. Based on such understanding, the technical solutions of the embodiments of the present disclosure essentially or the portion thereof contributing to the prior art may be embodied in the form of a software product. The computer software product may be stored in a storage medium, such as a ROM/RAM, a magnetic disk, an optical disk, etc., and includes several instructions such that a computer device (may be a personal computer, a server, or a network device, etc.) implements the methods described in various embodiments or certain portions of the embodiments of the present disclosure.

The system, apparatus, module, or unit illustrated in the above embodiments may be specifically implemented by a computer chip or an entity, or implemented by a product having a certain function. A typical implementation device is a computer. A specific form of the computer may be a personal computer, a laptop computer, a cellular phone, a camera phone, a smart phone, a personal digital assistant, a media player, a navigation device, an email transceiver device, a game console, a tablet computer, a wearable device, or a combination of any of these devices.

All of the embodiments in the description are described in a progressive manner, and identical or similar parts in various embodiments can refer to one another. The description for each embodiment focuses on the differences from other embodiments. In particular, the apparatus embodiments are described briefly, since they are substantially similar to the method embodiments, and the related contents can refer to the description of the method embodiments. The apparatus embodiments described above are merely schematic. The modules described as separate components may or may not be physically separate, and functions of various modules may be implemented in a same or more software and/or hardware when implementing the solutions of the embodiments of the present disclosure. A part or all of modules may also be selected according to actual needs to achieve the purpose of the solutions in these embodiments. Those skilled in the art may understand and implement other embodiments without a creative work.

The above descriptions are only specific implementations of the embodiments of the present disclosure. It should be noted that those skilled in the art may also make several improvements and modifications without departing from principles of the embodiments of the present disclosure, and these improvements and modifications should also be regarded as protection of the embodiments of the present disclosure.

In the present disclosure, the terms “first” and “second” are used solely for descriptive purposes and should not be understood as indicating or implying relative importance. The term “multiple” refer to two or more, unless explicitly defined otherwise.

Those skilled in the art will easily come up with other implementation solutions of the present disclosure after considering the description and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The description and embodiments are only considered exemplary, and the true scope and spirit of the present disclosure are indicated by the following claims. It should be understood that the present disclosure is not limited to the precise structure described above and shown in the drawings, and various modifications and changes may be made without departing from its scope. The scope of the present disclosure is limited only by the appended claims.

1. A page rendering method, comprising:
obtaining a domain-specific-language (DSL) file describing a target page comprising one or more controls;
creating a control tree structure comprising one or more control instances by parsing the obtained DSL file; and
rendering the target page according to the created control tree structure;
wherein each of the control instances in the control tree structure comprises a rendering function and a DSL attribute;
wherein, for each control instance of the control instances in the control tree structure, a value of the DSL attribute of the each control instance comprises DSL data describing the each control instance, and the rendering function of the each control instance is configured for rendering a corresponding control according to a current attribute value of the each control instance which is determined from the DSL data within a current value of the DSL attribute of the each control instance.

2. The method of claim 1, further comprising updating the target page, wherein the updating the target page specifically comprises:
obtaining control update data,
determining a to-be-updated target control instance and updating the DSL data in the target control instance according to the obtained control update data,
executing the rendering function in the updated target control instance to update and render a control corresponding to the target control instance in the target page.

3. The method of claim 2, further comprising: creating a corresponding state instance for the each control instance;
wherein different control instances correspond to different state instances, and each of the state instances is enabled to execute the rendering function in a corresponding control instance;
wherein the executing the rendering function in the updated target control instance comprises: invoking a state instance corresponding to the target control instance to execute the rendering function in the updated target control instance.

4. The method of claim 3, wherein each of the state instances is further configured for updating a value of the DSL attribute in the corresponding control instance;
wherein the updating the DSL data in the target control instance comprises: invoking the state instance corresponding to the target control instance to update the DSL data in the target control instance according to the control update data.

5. The method of claim 2, wherein the obtaining control update data comprises:
obtaining the control update data according to a local event execution result; and/or
obtaining the control update data sent by an external device.

6. The method of claim 1, wherein a root node of the control tree structure comprises a notification center control instance;
wherein the notification center control instance is configured for: in response to receiving a control interaction event, executing, according to a set of correspondences between information of the control instances and operation events, a corresponding operation event for information of an interacted control instance to obtain an event execution result.

7. The method of claim 2, wherein the obtaining control update data comprises:
obtaining attribute update information of a to-be-updated control; and
converting the attribute update information into the control update data in a DSL form.

8. The method of claim 1, wherein the obtaining the DSL file comprises:
obtaining configuration information of the target page, wherein the configuration information comprises information of the control tree structure; and
converting the configuration information into the DSL file.

9. The method of claim 1, wherein the DSL file comprises at least one of control information, event binding information, or data binding information describing the control tree structure; and the DSL file comprises at least the control information;
wherein the method further comprises:
executing initialization;
wherein the method further comprises at least one of:
saving the event binding information in the DSL file;
saving the data binding information in the DSL file; or
saving the control information in the DSL file;
wherein the method comprises at least: the step of saving the control information in the DSL file;
wherein the creating a control tree structure comprising one or more control instances by parsing the obtained DSL file comprises:
creating the control tree structure comprising the control instances by parsing the control information.

10. The method of claim 1, wherein the rendering the target page according to the created control tree structure comprises:
executing an initialization event for the target page;
determining a to-be-updated initial control instance and updating the DSL data in the determined initial control instance according to a result of executing the initialization event; and
executing the rendering function in each of the control instances in the control tree structure to render corresponding controls and obtain the target page.

11. The method of claim 1, wherein the rendering function comprises a construction function;
the method further comprises:
in a process of creating the control tree structure, executing the construction function in each of the control instances comprised in the control tree structure, to render corresponding controls and obtain the target page.

12. The method of claim 11, further comprising:
executing an initialization event for the target page;
determining a to-be-updated initial control instance and updating the DSL data in the determined initial control instance according to a result of executing the initialization event; and
executing the rendering function in the updated initial control instance to update and render a corresponding control in the target page.

13. The method of claim 1, wherein the method further comprises:
creating a control instance of a control type by parsing DSL data describing the control instance of the control type;
wherein the parsing the obtained DSL file comprises:
parsing the DSL data for DSL data describing a control instance of a target control type in the obtained DSL file.

14. The method of claim 8, wherein the method further comprises:
converting codes for a control instance of the control type into DSL data describing the control instance of the control type.

15. A page rendering method, applied to a development end and comprising:
obtaining configuration information of a target page, wherein the configuration information comprises information of a control tree structure; and
converting the configuration information into a domain-specific-language (DSL) file describing the target page;
wherein a result of parsing the DSL file is configured for creating the control tree structure comprising one or more control instances; and the created control tree structure is configured for rendering the target page;
wherein each of the control instances in the control tree structure comprises a rendering function and a DSL attribute;
wherein, for each control instance of the control instances in the control tree structure, a value of the DSL attribute of the each control instance comprises DSL data describing the each control instance, and the rendering function of the each control instance is configured for rendering a corresponding control according to a current attribute value of the each control instance which is determined from the DSL data within a current value of the DSL attribute of the each control instance.

16. A page rendering method, comprising:
obtaining, by a development end, configuration information of a target page, wherein the configuration information comprises information of a control tree structure;
converting, by the development end, the configuration information into a domain-specific-language (DSL) file describing the target page;
obtaining, by a rendering end, the DSL file; and
parsing, by the rendering end, the obtained DSL file to create the control tree structure comprising one or more control instances and render the target page according to the created control tree structure;
wherein each of the control instances in the control tree structure comprises a rendering function and a DSL attribute;
wherein, for each control instance of the control instances in the control tree structure, a value of the DSL attribute of the each control instance comprises DSL data describing the each control instance, and the rendering function of the each control instance is configured for rendering a corresponding control according to a current attribute value of the each control instance which is determined from the DSL data within a current value of the DSL attribute of the each control instance.

17-19. (canceled)

20. An electronic device, comprising:
at least one processor; and
a memory connected communicatively to the at least one processor, wherein,
the memory stores instructions that are executable by the at least one processor, and the instructions are executed by the at least one processor, such that the at least one processor can execute the method of claim 1.

21. A non-transitory computer-readable storage medium storing a computer program, wherein a processor, when executing the computer program, implements the method of claim 1.

22. An electronic device, comprising:
at least one processor; and
a memory connected communicatively to the at least one processor, wherein,
the memory stores instructions that are executable by the at least one processor, and the instructions are executed by the at least one processor, such that the at least one processor can execute the method of claim 15.

23. A non-transitory computer-readable storage medium storing a computer program, wherein a processor, when executing the computer program, implements the method of claim 15.
